(19) United States
(12) Patent Application Publication
(10) Pub. No.: US 2025/0334409 A1
(43) Pub. Date: Oct. 30, 2025

(54) SYSTEM AND METHODS FOR A REMOVABLE COMPASS

(71) Applicant: Karrah Lynn Kightlinger, Erie, PA (US)

(72) Inventor: Karrah Lynn Kightlinger, Erie, PA (US)

(21) Appl. No.: 19/187,078

(22) Filed: Apr. 23, 2025

Related U.S. Application Data
(60) Provisional application No. 63/638,094, filed on Apr. 24, 2024.

(51) Int. Cl. G01C 17/18; G01C 17/24

(52) U.S. Cl. CPC G01C 17/18; G01C 17/24

(57) ABSTRACT

The present disclosure teaches a compass system. The compass system may include a compass assembly and a sleeve. The compass assembly may include a compass, a compass casing, and a release mechanism. The compass may be configured to be detachably secured within the compass casing and the sleeve may be connectable to the compass casing. The release mechanism may be configured to release the compass from the compass casing and the sleeve may be configured to be securable to an external object.

### REFERENCE TO RELATED APPLICATIONS

The present application is a continuation application of U.S. Provisional Patent Application Ser. No. 63/638,094, filed Apr. 24, 2024, wherein this disclosure is hereby incorporated by reference in its entirety.

### TECHNICAL FIELD

Versions of the technology relate, in general, to direction determining apparatuses. In particular, versions of the technology relate to a secured but easily removable compass serving as an accessory for a means of transportation with a shift knob or other device, as a means of navigation.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 is an isometric view of a compass system of the present disclosure attached to a shift knob of a vehicle utilizing an integrated sleeve assembly;

FIG. 2 is a side view of the compass system and integrated sleeve assembly of FIG. 1 not attached to the shift knob;

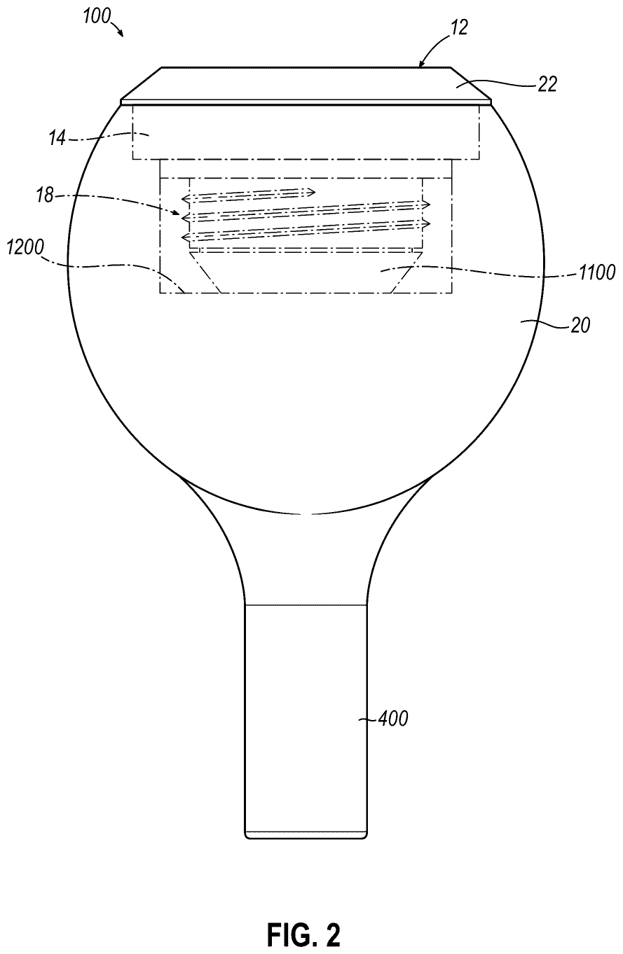

FIG. 3 is a side view of an integrated compass assembly of the compass system of FIG. 1;

FIG. 4 is a side section view of a compass of the compass assembly of FIG. 3;

FIG. 5 is an isometric view of the compass assembly of FIG. 3 with an attached lanyard;

FIG. 6A is an isometric view of a twist-to-release mechanism secured to a release base of the compass assembly of the present disclosure;

FIG. 6B is an isometric view of the twist-to-release mechanism of FIG. 6A separated from the release base;

FIG. 6C is an isometric view of the release base of FIG. 6A separated from the twist-to-release mechanism;

FIG. 7A is a partial cross-sectional view of a compass system with an integrated vertical axis not attached to the shift knob;

FIG. 7B is an additional partial cross-sectional view of the compass system of FIG. 7A not attached to the shift knob;

FIG. 8A is an isometric view of a first portion of a push-to-pop compass assembly;

FIG. 8B is an underside view of the push-to-pop compass assembly of FIG. 8A; and

FIG. 8C is an isometric view of a second portion of the push-to-pop compass assembly of FIG. 8A secured to integrated sleeve assembly.

The drawings are not intended to be limiting in any way, and it is contemplated that various versions of the technology may be carried out in a variety of other ways, including those not necessarily depicted in the drawings. The accompanying drawings incorporated in and forming a part of the specification illustrate several aspects of the present technology, and together with the description explain the principles of the technology; it being understood, however, that this technology is not limited to the precise arrangements shown.

### DETAILED DESCRIPTION

Various non-limiting versions of the present disclosure can now be described to provide an overall understanding of the principles of the structure, function, and use of the apparatuses, systems, features and methods disclosed herein. One or more examples of these non-limiting versions are illustrated in the accompanying drawings. Those of ordinary skill in the art can understand that systems and methods specifically described herein and illustrated in the accompanying drawings are non-limiting versions. The features illustrated or described in connection with one non-limiting version may be combined with the features of other non-limiting versions. Such modifications and variations are intended to be included within the scope of the present disclosure.

Reference throughout the specification to “various versions,” “some versions,” “one version,” “some example versions,” “one example version,” or “a version” means that a particular feature, structure, or characteristic described in connection with any version is included in at least one version. Thus, appearances of the phrases “in various versions,” “in some versions,” “in one version,” “some example versions,” “one example version,” or “in a version” in places throughout the specification are not necessarily all referring to the same version. Furthermore, the particular features, structures or characteristics may be combined in any suitable manner in one or more versions.

Described herein are example versions of apparatuses and systems for a removable compass system 100 designed for deployment with transportation vehicles, offering enhanced usability features. In one or more versions, compass system 100 includes an integrated compass assembly 10 and a sleeve 20, along with other modifications as described in more detail below. In one or more versions, integrated compass assembly 10 includes a compass 12, a release mechanism 18, and a compass casing 22.

In one or more versions, compass 12 includes a magnetic sensor element configured to detect and indicate cardinal directions. In one or more versions, compass 12 incorporates luminescent elements or backlighting for optimal visibility during low-light conditions. In other versions, compass 12 may be buoyant, waterproof, and/or shatterproof.

In some versions, compass casing 22 may be constructed from a durable, impact-resistant material, such as a combination of lightweight materials such as, but not limited to, plastic, bamboo, polyurethane, silica, or combinations thereof and robust materials such as, but not limited to reinforced plastics, hydrogels, neoprene, composites, silica, bamboo, metal alloys, or combinations thereof). This material choice provides protection against physical impacts and environmental conditions. In one or more versions, compass casing 22 incorporates a shock-absorbing element such as, but not limited to, cork, sponge, gel, silicone, rubber, non-compressing foam, or combinations thereof). In some versions, compass casing 22 includes a cushioning structure, such as air pockets, silicone, gel, rubber, cork, sponge, non-compressing foam material, or combinations thereof. Shock absorbing elements and cushioning structures may be present to safeguard compass 12 from mechanical shocks, vibrations, and external forces that may otherwise affect directional accuracy.

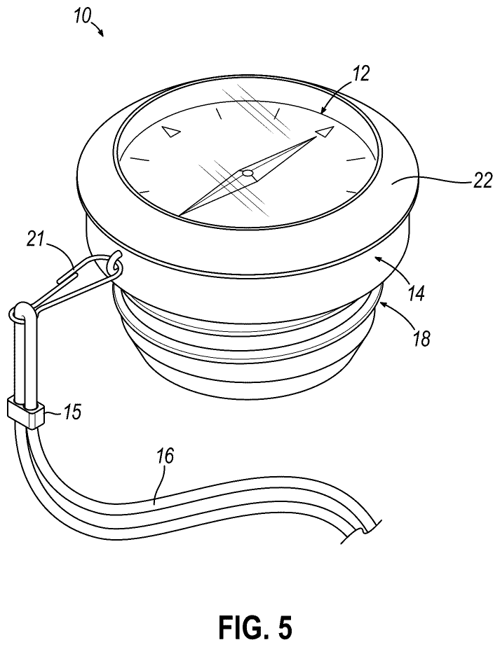

In one or more versions, compass casing 22 contains a lanyard compartment 14 and a lanyard 16, such as shown in FIG. 5. Lanyard compartment 14 may be used to contain lanyard 16 when integrated compass assembly 10 is secured within compass system 100. Lanyard 16 may be removed from lanyard compartment 14 at a time when integrated compass assembly 10 is removed from sleeve 20 for use outside of a vehicle. In some versions, lanyard 16 includes a flexible strap designed for comfortable wear around the neck or attachment to clothing and a lanyard attachment device 21, such as shown in FIG. 5. In one or more versions, lanyard attachment device 21 can be used to attach lanyard 16 to compass casing 22. In some versions, attachment device 21 can be attached to compass casing through a hook and hole mechanism.

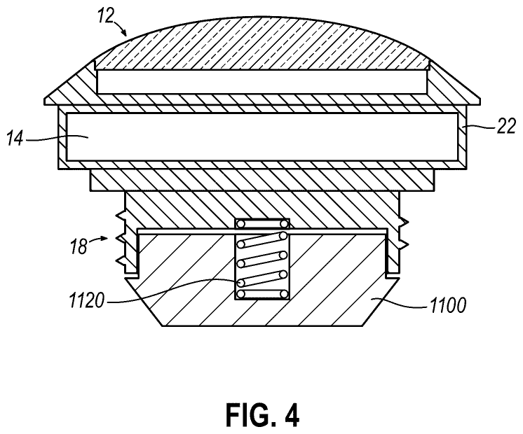

In various versions, lanyard 16 can have differing lengths, widths, and designs. In one or more versions, lanyard 16 may include an adjustable length mechanism 15, which allows users to change a length of lanyard 16 to their preferred size. In some versions, adjustable length mechanism 15 includes adjustable sliders, clips, or other components that securely hold lanyard 16 at the desired length. In one or more versions, lanyard compartment 14 may be strategically located within compass casing 22, such as shown in FIG. 4, optimizing the use of available space and maintaining an overall compact form factor of compass 12. In one or more versions, lanyard compartment 14 may be designed to securely hold lanyard 16 when not in use, preventing entanglement or interference with the compass 12.

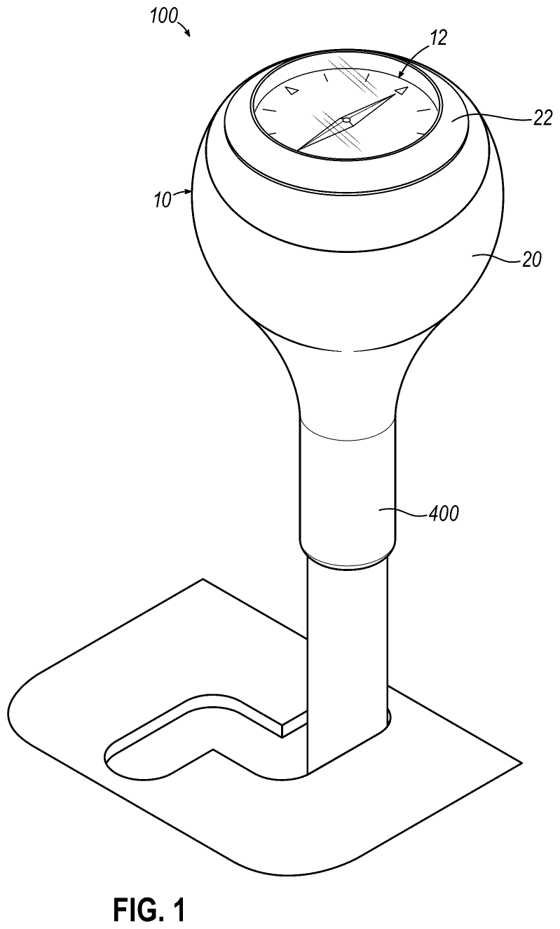

In some versions, compass system 100 may include features to enhance usability, such as a secure fitting mechanism for attachment within different transportation modes. In one or more versions, integrated compass assembly 10 may be configured to float in water. In some example versions, compass system 100 may be configured to removably attach to any shift knob, such as shift knob 400 shown in FIG. 1, or such as one found in a boat's throttle assembly, an off-road vehicle such as an ATV, a snowmobile, a motorcycle, a jet-ski, an airplane or ultra-light or other transportation vehicle. In other versions, compass system 100 may be attached to a golf club shaft or grip, a ski-pole, a walking stick, or other shaft/knob-like structure.

In one or more versions, sleeve 20 incorporates a form-fitting shape that adheres closely to the contours of a shift knob, ensuring a secure and ergonomic attachment without compromising the ease of use or functionality of the shift knob. In some versions, sleeve 20 is made of material that is pliable and conforming, allowing compass system 100 to be attached to a shift knob of a vehicle merely by stretching sleeve 20 over the vehicle's shift knob. In one or more versions, such material for sleeve 20 may include silicone, plastic, neoprene, spandex, vinyl, leather, or combinations thereof.

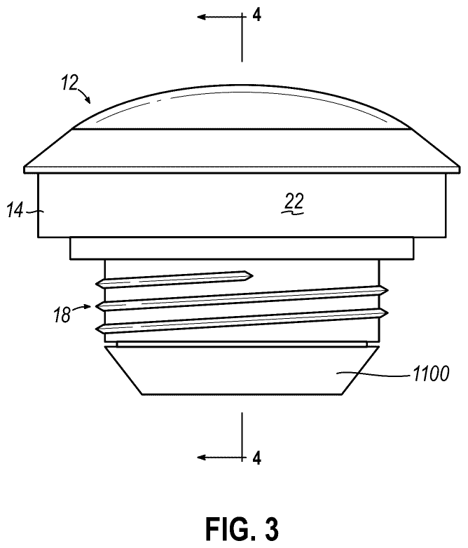

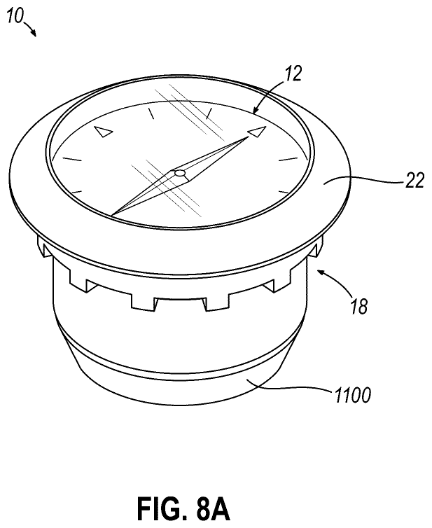

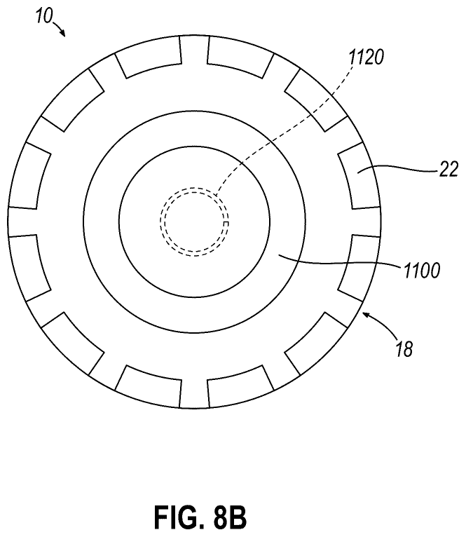

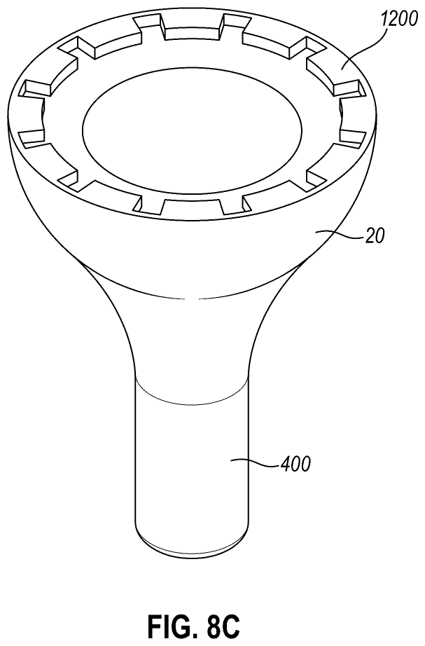

In one or more versions, release mechanism 18 is a push-to-pop mechanism 18, such as shown in FIGS. 3 and 8A through 8C. When release mechanism 18 is a push-to-pop mechanism, it may include a first portion 1100 which may include a spring 1120 to bias first portion 1100 when attached to compass casing 22 so as to reduce vibration and shock to compass 12 when a vehicle experiences rough conditions during travel and a second portion 1200 secured to sleeve 20. In one or more versions, pushing a face of compass 12 down towards first portion 1100 will alternately engage and release first portion 1100 in order for the operator to remove integrated compass system 10 from a vehicle. In one version, a mechanism similar to a ball-point pen which is extendable and retractable by pressing a thumb on a plunger is used to alternately attach and detach integrated compass assembly 10 from compass system 100. In one or more versions, push-to-pop mechanism 18 serves as an attachment interface for integrating compass 12 with transportation accessories.

In one or more versions, when release mechanism 18 is a push-to-pop mechanism, it allows a user to effortlessly attach and detach compass assembly 10 from compass system 100, ensuring a secure connection during operation. In one version, when release mechanism 18 is a push-to-pop mechanism it may include a user-friendly interface that enables quick deployment of compass assembly 10 by applying a pushing force. Push-to-pop mechanism may be configured to securely hold the compass 12 in place during transportation, preventing dislodgement or damage.

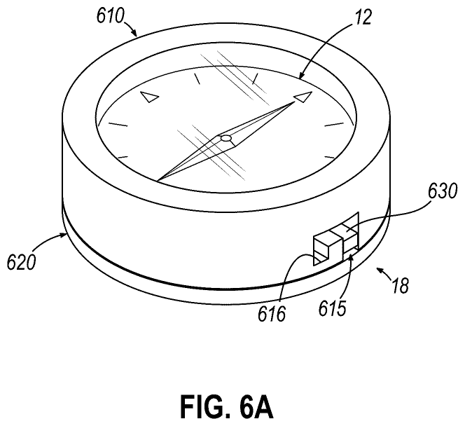

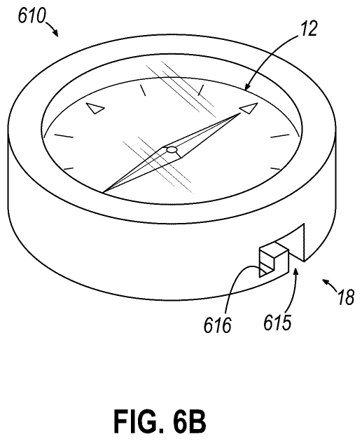

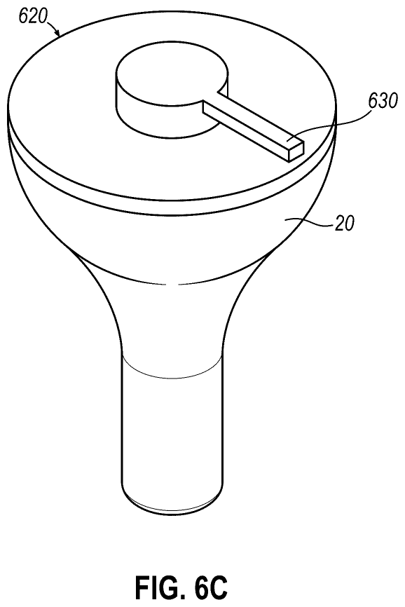

In other versions, such as shown in FIG. 6A release mechanism 18 is a twist-to-release mechanism. As shown in FIG. 6A-6C, when release mechanism 18 is a twist-to-release mechanism it may include an alternative compass casing 610 and a release base 620. Alternative compass casing 610 is rotatable relative to release base 620 to attach and detach alternative compass casing 610 from release base 620. Alternative compass casing 610 may include a channel 615 that removably mates with a pin 630 attached to release base 620. Pin 630 may extend outside compass casing 610 in order to allow an operator to manually move pin 630. In some versions, channel 615 includes a recess 616 that pin 630 biases into for a more secure locking of alternative compass casing 610 to release base 620 until the operator lifts pin 630 out of channel 615 and rotates alternative compass casing 610 to remove compass 12 from a vehicle. In one or more versions, release base 620 is permanently attached to sleeve 20 and may be annular in order to sit flush against a shift knob.

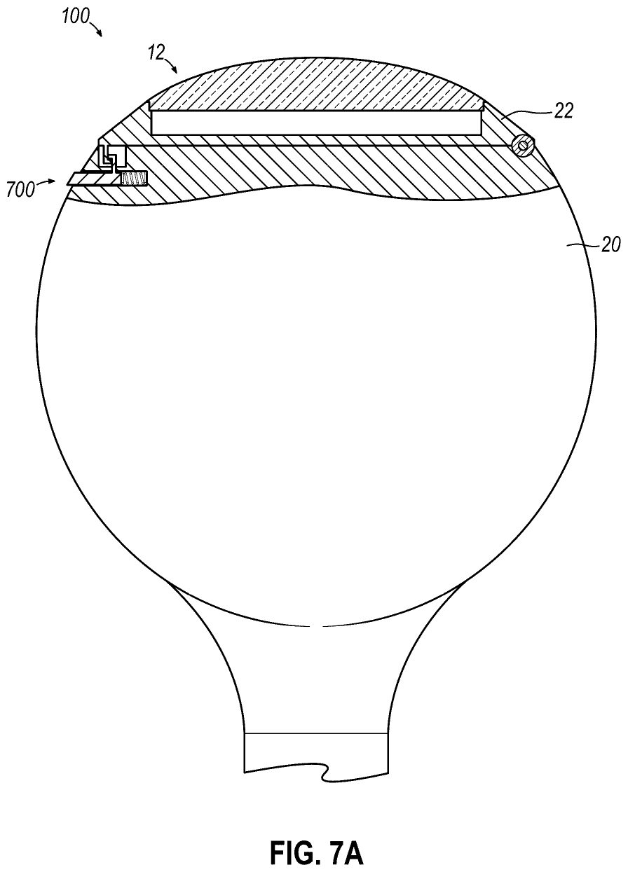

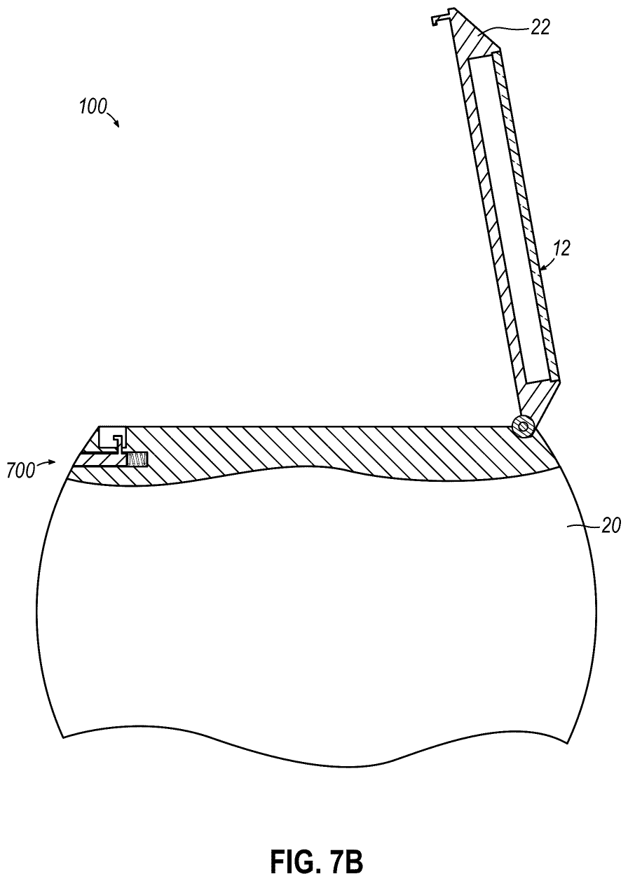

In one or more versions, compass system 100 may include an adjustable axis mechanism 700 as shown in FIGS. 7A and 7B. Adjustable axis mechanism 700 can be used to alter the axis on which integrated compass assembly 10 sits from completely horizontal to completely vertical. An axis of compass assembly 10 is a line through the center point of the face of compass 12, through to release mechanism 18 and sleeve 20 when compass assembly 10 is in the completely horizontal orientation. In the completely horizontal orientation, the axis of compass assembly 10 may be parallel to an axis of a shift knob, as shown in FIG. 7A. In a completely vertical orientation, axis of compass assembly 10 may be perpendicular to an axis of a shift knob, such as shown in FIG. 7B, through the utilization of adjustable axis mechanism 700.

Numerous advantages can be associated with compass system 100 of the present disclosure. Such advantages may include an innovative and versatile solution for integrating analog navigation tools within transportation accessories, catering to users in scenarios where conventional navigational aids may be compromised. Compass system 100 may be a safeguard in the event of getting stranded in an area with no cell service or loss of power. Further, some versions of compass system 100 incorporate features that enhance usability during nighttime or low-light conditions, making compass system 100 a reliable navigation tool in various environmental settings.

### Illustrative Combinations.

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A compass system, comprising: a compass assembly, said compass assembly including: a compass; a compass casing, said compass being configured to be detachably secured within the compass casing; and a release mechanism; and a sleeve designed to be connectable to the compass casing; said release mechanism being configured to release compass from compass casing, and wherein said sleeve being configured to be securable to an external object.

### Example 2

The compass system of Example 1, wherein the compass casing further comprises a lanyard compartment configured to securely hold a lanyard.

### Example 3

The compass system of Example 2 wherein the lanyard has an adjustable length mechanism.

### Example 4

The compass system of Example 1, wherein the compass casing is constructed from a durable, impact-resistant material.

### Example 5

The compass system of Example 1, wherein the compass casing contains at least one of: a shock-absorbing element; or a cushioning structure.

### Example 6

The compass system of Example 1, wherein the compass further comprises luminescent elements or backlighting.

### Example 7

The compass system of Example 1, wherein the sleeve is constructed from a flexible and resilient material composition.

### Example 8

The compass system of Example 1, wherein the compass casing is constructed from a combination of lightweight and robust materials, providing protection against physical impacts and environmental conditions.

### Example 9

The compass system of Example 1, wherein the release mechanism is a push-to-pop mechanism.

### Example 10

The compass system of Example 9, wherein the push-to-pop mechanism includes a first portion secured to the compass casing, and a second portion secured to the sleeve.

### Example 11

The compass system of Example 10, wherein the first portion further includes a spring to bias first portion into a securable relationship with the second portion.

### Example 12

The compass system of Example 1, wherein the release mechanism is a twist-to-release mechanism.

### Example 13

The compass system of Example 12, wherein the compass casing is a first portion of the twist-to-release mechanism, and wherein the twist-to-release mechanism further includes a second portion securable to the sleeve.

### Example 14

The compass system of Example 13, wherein the first portion of the twist-to-release mechanism further includes a channel, and wherein the second portion of the twist-to-release mechanism further includes a pin; wherein said pin is removably securable within the channel to secure the first portion of the twist-to-release mechanism with the second portion of the twist-to-release mechanism.

### Example 15

The compass system of Example 1, wherein the compass casing further includes an adjustable axis mechanism.

### Miscellaneous.

It should be understood that any of the versions of the compass systems described herein may include various other features in addition to or in lieu of those described above. By way of example only, any of the compass systems described herein may also include one or more of the various features disclosed in any of the various references that are incorporated by reference herein. It should also be understood that the teachings herein may be readily applied to any of the compass systems described in any of the other references cited herein, such that the teachings herein may be readily combined with the teachings of any of the references cited herein in numerous ways. Other types of compass systems into which the teachings herein may be incorporated will be apparent to those of ordinary skill in the art.

It should also be understood that any ranges of values referred to herein should be read to include the upper and lower boundaries of such ranges. For instance, a range expressed as ranging “between approximately 1.0 inches and approximately 1.5 inches” should be read to include approximately 1.0 inches and approximately 1.5 inches, in addition to including the values between those upper and lower boundaries.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A compass system, comprising:
a. a compass assembly, said compass assembly including:
i. a compass;
ii. a compass casing, said compass being configured to be detachably secured within the compass casing; and
iii. a release mechanism; and
b. a sleeve designed to be connectable to the compass casing;
said release mechanism being configured to release compass from compass casing, and wherein said sleeve being configured to be securable to an external object.

2. The compass system of claim 1, wherein the compass casing further comprises a lanyard compartment configured to securely hold a lanyard.

3. The compass system of claim 2 wherein the lanyard has an adjustable length mechanism.

4. The compass system of claim 1, wherein the compass casing is constructed from a durable, impact-resistant material.

5. The compass system of claim 1, wherein the compass casing contains at least one of:
a. a shock-absorbing element; or
b. a cushioning structure.

6. The compass system of claim 1, wherein the compass further comprises luminescent elements or backlighting.

7. The compass system of claim 1, wherein the sleeve is constructed from a flexible and resilient material composition.

8. The compass system of claim 1, wherein the compass casing is constructed from a combination of lightweight and robust materials, providing protection against physical impacts and environmental conditions.

9. The compass system of claim 1, wherein the release mechanism is a push-to-pop mechanism.

10. The compass system of claim 9, wherein the push-to-pop mechanism includes a first portion secured to the compass casing, and a second portion secured to the sleeve.

11. The compass system of claim 10, wherein the first portion further includes a spring to bias first portion into a securable relationship with the second portion.

12. The compass system of claim 1, wherein the release mechanism is a twist-to-release mechanism.

13. The compass system of claim 12, wherein the compass casing is a first portion of the twist-to-release mechanism, and wherein the twist-to-release mechanism further includes a second portion securable to the sleeve.

14. The compass system of claim 13, wherein the first portion of the twist-to-release mechanism further includes a channel, and wherein the second portion of the twist-to-release mechanism further includes a pin; wherein said pin is removably securable within the channel to secure the first portion of the twist-to-release mechanism with the second portion of the twist-to-release mechanism.

15. The compass system of claim 1, wherein the compass casing further includes an adjustable axis mechanism.
